(19) United States
(12) Patent Application Publication
(10) Pub. No.: US 2005/0118324 A1
(43) Pub. Date: Jun. 2, 2005

(54) Good living tea - a diabetic dietary supplement drink

(76) Inventors: Anna Molly Mathew, Yukon, OK (US); Thomas M. Mathew, Yukon, OK (US)

Correspondence Address: ANNA MOLLY MATHEW, 521 CONESTOGA DR, YUKON, OK, 73099, US

(21) Appl. No.: 10/726,146

(22) Filed: Dec. 2, 2003

(51) Int. Cl. A23L 1/28

(52) U.S. Cl. 426/655

(57) ABSTRACT

A new invention, Good Living Tea was created specifically for those with diabetes. Good Living Tea is a tea specially blended with herbs and spices which lowers the glucose level in diabetic people. Good Living Tea is a dietary supplement which increases the insulin output, therefore lowering the glucose level. Good Living Tea is not a cure for diabetes and cannot control one's sugar level alone, but along with medication, diet, and exercise, “Good Living Tea” can be a useful dietary supplement in the control of one's diabetes. A composition of matter of Tea with the steps of adding boiling clean water to one premixed tea bag per cup. The ingredients in this unique blend of Teas are: dried Bitter melon leaves, ground Fenugreek, ground Cinnamon, dried Parsley flakes, and Pathimukham. This should give a light-reddish drink that is refreshing and invigorating.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Food and Agriculture products, and more specifically to a composition of matter comprising Herbs and Spices. Millions of people world wide are affected by diabetes mellitus. An estimated 20 million Americans are diagnosed with diabetes, and the number is growing at an alarming rate. It is a common disorder which necessitates a change in life style among those inflicted. Diabetes mellitus is caused by insufficient production of insulin and is characterized by increased sugar in blood and urine. The main symptoms of the disorder are excessive thirst, frequent urination and sweating. The invention of Good Living Tea has been the result of the inventor's own search for a drink that is healthy for diabetes people. The inventor is a diabetes II patient, and initially this tea was developed for her own use.

Ingredients used in the “Good living Tea” have been tested scientifically and proven to help people with diabetes. I formulated a drink that was both Favorable and soothing. I was surprised to find out how much this tea lowered my blood sugar level and boosted my energy. I made a few tea bags on a trial basis and distributed among family and friends for testing, and the feed back I received was very positive. So I decided to patent and market this product so that others can benefit from the use of it. It stem from a desire to help other people with diabetes more than the financial benefits.

There is no cure for diabetes. Good living Tea is not a cure for diabetes. Type I diabetes-intensified insulin therapy, which is designed to mimic the how of insulin in healthy humans. Type II diabetes uses oral hypoglycemic agents include sulfate drugs like diabenes, glucotrol, micronase, and orinase. These drugs seems to enhance insulin production and sensitivity of the body cells to insulin.

### HISTORY OF TECHNOLOGY

The components of this Tea have been used for many years in many Asian countries such as India.

Hundreds of research studies have been conducted world wide on the plant “bitter melon”, which is the main ingredients in the Good Living Tea. At least three parts of constituents found in all parts of bitter melon have clinically demonstrated hypoglycemic properties (blood sugar lowering), or other actions of potential benefit against diabetes mellitus.

The dried bitter melon leaves, FennuGreek, Cinnamon, Parsley leaves are medically proven to increase body's production of insulin.

The Cinnamon is for taste as well, since the other said ingredients do not contain a certain flavor. In research study, Cinnamon was found to be extremely effective in increasing the body's production of insulin. The dried bittermelon leaves lowers one's blood-sugar level. Pathimukam adds a light-reddish color to the Tea.

### DEFICIENCY IN PRIOR TECHNOLOGY

Most Teas do not claim to help those with Diabetes. The ingredients in this tea are ingredients that will help the production of insulin and control blood sugar levels. Black and Green Teas have definite tastes. With Good Living Tea, you may add flavors to this tea and still not alter the effects. There are many diet soft drinks in the market, but not many beverages are specifically centered at Diabetics, Good Living Tea provide a breath of fresh air to those with diabetes as an alternate healthy beverage.

### OBJECT OF THE INVENTION

The primary object of the invention in “Good living Tea” is to provide a Tea that reduces the symptoms of Diabetes.

Another object of the invention is, “Good living Tea” is a dietary supplement which increase production of insulin outputs thus lowering the glucose level in the body.

Another object of the invention is to provide a Tea that tastes better than most Medicinal teas.

Another object of the invention is “Good living Tea” has a soothing and refreshing Taste which can quench the thirst of diabetes people.

A further object of the invention is, to provide a Versatile tea that has more than one flavor and can be an invigorating drink.

### DETAILED DESCRIPTION OF THE INVENTION

In accordance with a preferred embodiment of the invention, there is disclosed a composition of matter comprising Herbs and Spices, Dried Bitter melon leaves; Momordica Charantia (botanical name) (Also known as Bittergourd, papailla, balsam apple, and pava-akai) FenuGreek; Trigonella Foenum Graecum (botanical name) Ground Cinnamon; Cinnamomum Cassia (botanical name) Dried Parsley Flakes: Petroselinum crispum (botanical name) Pathimukham: A pink colored herb.

Hundreds of research studies have been conducted world wide on the plant “bitter melon”, which is the main ingredients in the Good Living Tea. At least three parts of constituents found in all parts of bitter melon have clinically demonstrated hypoglycemic properties (blood sugar lowering), or other actions of potential benefit against diabetes mellitus.

The dried bitter melon leaves, FennuGreek, Cinnamon, Parsley leaves are medically proven to increase body's production of insulin.

The Cinnamon is for taste as well, since the other said ingredients do not contain a certain flavor. In research study, Cinnamon was found to be extremely effective in increasing the body's production of insulin. The dried bittermelon leaves lowers one's blood-sugar level. Pathimukam adds a light-reddish color to the Tea.

When all of these products are combined together, they provide a powerful effect On the production of insulin and the blood-sugar levels of the body.

These above mentioned ingredients will be blended together in the precise proportions to make individual tea bags weighing approximately 2.0 grams. Also family size tea bags will be created using the same formula weighing approximately 8.0 grams. Pour hot boiling water to tea bag in a cup or put tea bags in kettle to make delicious tea. Tea will be made in Regular flavor, as well as Lemon flavor, Mint flavor, Orange spice flavor, and Vanilla flavor. Tea may be served hot or cold with ice any time and as often as preferred.

There are many varieties of teas and diet soft drinks in the market. But there are not many teas or soft drinks that precisely help reduce symptoms of diabetes. Even though, the blend of “Good living Tea” is new, the components of this tea has been used for many years in Asian countries such as India. The dried bitter melon leaves, Fennugreek, Cinnamon, and Parsley leaves are medically proven to increase body's production of insulin. The dried bitter melon leaves lowers one's blood-sugar level. Hundreds of scientific studies have been conducted world wide to prove the health benefit of using bitter melon plants and fruits. (see Technical data report. Herbal secrets of the Rain Forest, published and copy righted by sage press inc.)

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, on the contrary, it is intended to cover such alternatives, modifications, and equivalents as may be included with in the spirit and scope of the invention as defined by the appended claims.

Benefit of the Claim:

To provide a Tea that reduces the symptoms of Diabetes.
To provide a Tea that is a dietary Supplement for the people with diabetes.
To provide a Tea that tastes better than most medicinal Teas.
To provide a drink that is sugar free and a thirst quencher for people with diabetes.
To provide a drink for diabetes that is all natural.
To provide a choice drink that is easy to make and economical.
To provide a soothing drink in many different flavors such as mint, lemon, orange spice . . . etc.

1.
A1 A composition of matter of Tea comprising:
Boiling water;
A2 A composition of matter of Tea comprising:
Chopped dried Bitter melon leaves; (Momordica Charantia)
Also known as bittergourd, papailla, balsam pear, and pava-kai
A3 A composition of matter of Tea comprising:
Fenugreek: (Trigonella Foenum graecum)
A4 A composition of matter of Tea comprising:
Ground Cinnamon: (Cinnamomum Cassia)
A5 A composition of matter of Tea comprising:
Dried parsley leaf: (Petroselinum Crispum)
A6 A composition of Tea comprising:
Pathimukham
B1 A method for making Tea comprising:
Boiling a pot of water
Place one “Good living Tea” bag in a cup and pour hot water
Allow 2 to 3 min. to steep
Add lemon or mint for flavor if preferred
Drink as hot Tea or add ice cubes to make iced Tea
